(19) United States
(12) Patent Application Publication
(10) Pub. No.: US 2009/0220913 A1
(43) Pub. Date: Sep. 3, 2009

(54) Enossal Implant Comprising an Anatase Coating

(75) Inventors: Juergen Geis-Gerstorfer, Ofterdingen (DE); Martin Fricke, Erfurt (DE)

Correspondence Address: WILLIAM D. BRENEMAN, ESQ.;BRENEMAN & GEORGES, 3150 COMMONWEALTH AVENUE, ALEXANDRIA, VA, 22305, US

(73) Assignee: EBERHARD-KARLS-UNIVERSITAET, Tuebingen (DE)

(21) Appl. No.: 12/226,989

(22) PCT Filed: May 4, 2007
(86) PCT No.: PCT/DE2007/000813

§ 371 Date: Feb. 17, 2009

(30) Foreign Application Priority Data
May 4, 2006 (DE) 10 2006 021 968.6

(51) Int. Cl. A61C 8/00

(52) U.S. Cl. 433/173; 433/215

(57) ABSTRACT

Disclosed is an enossal implant comprising a surface layer (28) which is made of the anatase modification of titanium dioxide and which is deposited on a base structure of the implant, preferably on an intermediate layer (26) of pure titanium, by means of a pulsed reactive magnetron sputtering process.

The invention relates to an enossal implant, with a base structure which is made of a base material and which has an anchoring area for anchoring in bone, a neck area, and an attachment area for receiving an element that is to be applied, such as an abutment or a crown, bridge or prosthesis construction, and is at least partially covered by a surface layer of titanium dioxide.

Enossal implants (dental implants) have been used successfully for over a decade. Most of the enossal implants used today are made of titanium, since titanium has a sufficiently low modulus of elasticity and a high degree of strength. Titanium has also been extensively tested as an implant material and has proven effective in long-term studies.

Moreover, titanium implants generally permit good osseointegration (ossification) if suitably configured. The question of whether reliable osseointegration can be guaranteed depends mainly on the nature and properties of the implant surface.

Prosthetic elements, for example bridges or crowns, are screwed or cemented onto the attachment part of enossal implants, generally with interpositioning of what are referred to as abutments.

Such an implant is known from U.S. Pat. No. 5,934,287, for example.

According to the aforementioned document, a coating is applied to the anchoring part of a titanium implant by a hydrothermal process, the aim being to achieve improved osseointegration. For this purpose, the coating has an intermediate layer of titanium dioxide and a surface layer of hydroxyapatite.

U.S. Pat. No. 6,183,255 discloses another enossal implant made of titanium, the outer face of which is coated with titanium dioxide having a crystalline structure that comprises a mixture of rutile with anatase and/or brookite.

The coating is in this case applied by a wet chemical method using sodium hydroxide.

Another enossal implant is known from WO-A-2005 055 860.

To improve osseointegration, use is made of a surface layer of titanium dioxide composed of crystalline titanium dioxide, which is to be present, mainly or completely, in the anatase modification. The surface layer is applied by anodic oxidation.

Although the known enossal implants mentioned above may in some cases lead to improved osseointegration, the results are still not satisfactory.

The object of the invention is therefore to make available an enossal implant, and a method for producing an enossal implant, by means of which good biocompatibility is obtained and the best possible osseointegration can be achieved.

According to the invention, this object is achieved by an enossal implant with a base structure which is made of a base material and which has an anchoring area for anchoring in bone, a neck area, and an attachment area for receiving an element that is to be applied, wherein the surface of the anchoring area has an intermediate layer of titanium and has a surface layer of titanium dioxide, which is composed mainly, preferably completely, of the anatase modification.

It has been found, according to the invention, that particularly good osseointegration can be achieved using a surface layer of titanium dioxide in the anatase modification. The intermediate layer of titanium permits particularly good adherence of the surface layer to the anchoring area.

In a preferred development of the invention, the neck area has another surface than the anchoring area.

In this way, the advantageous properties of the anatase surface layer in the anchoring area, which surface layer promotes good osseointegration, can be combined with what is as far as possible a bioinert property in the neck area of the implant. In the neck area, at the site where the implant passes through the oral mucosa, the implant should in fact allow the oral mucosa to accumulate as tightly as possible on the implant neck and avoid penetration of bacteria from the oral cavity to the jaw bone, since this could lead to inflammation around the implant (periimplantitis, mucositis).

For this purpose, the neck area can be uncoated, for example. If the base material of the implant is titanium or a titanium alloy, then the surface layer is passivated, as is known, by a thin surface layer of titanium dioxide, which in itself ensures relatively good stability.

According to another preferred embodiment of the invention, the neck area has an intermediate layer of titanium and a surface layer of titanium dioxide in the rutile modification.

This affords particularly good stability in the area of the implant neck, whereby a good accumulation of the oral mucosa on the smooth surface of the implant neck permits a “seal” between oral cavity and jaw bone. The risk of inflammation around the implant is minimized.

The smooth surface of the implant neck, in the sensitive area between implant neck and oral mucosa, is easier to clean and improves oral hygiene. The rutile surface layer has a natural, closed, and smooth surface with low microroughness/nanoroughness.

According to another embodiment of the invention, the implant is uncoated in the attachment area.

A coating is not generally necessary for the application of abutments, crowns, bridges or other prosthetic constructions.

According to another embodiment of the invention, the attachment area also has an intermediate layer of titanium and a surface layer of titanium dioxide in the rutile modification.

In such an embodiment, the whole area of the implant not anchored in the bone is provided with a smooth, substantially bioinert layer, which is also of advantage in terms of the healing period, which can generally amount to several months.

According to another embodiment of the invention, the base material is titanium or a titanium alloy.

The use of titanium or of a titanium alloy as the base material permits particularly advantageous adherence between intermediate layer and surface layer, resulting in a particularly abrasion-resistant attachment, which is also sufficiently resistant to abrasion when the anchoring part is being screwed into a corresponding hole in the bone.

According to another embodiment of the invention, the base material is composed of a plastic or a ceramic, in particular of a zirconium oxide material or an aluminum oxide material.

Implants of zirconium oxide material in particular, which have been developed recently, are distinguished by a very high degree of mechanical and chemical stability and have good biocompatibility. However, as it is difficult to achieve good osseointegration with implants made of zirconium oxide material, the application of the intermediate layer of titanium and of the surface layer of anatase, in accordance with the invention, also allows good osseointegration to be obtained with such a material.

According to another embodiment of the invention, the surface layer of anatase is designed as a photo-activatable layer.

By photoactivation, the anatase surface can be made superhydrophilic for a limited time. Thus, by means of photoactivation of the anatase layer directly before implantation, initial effects can be initiated at the interface between implant and bone tissue in order to obtain better and more rapid accumulation of bone tissue on the implant surface, such that improved osseointegration is achieved.

According to another embodiment of the invention, the base layer has a layer thickness of between 10 nm and 2000 nm, preferably of between 100 and 1000 nm, particularly preferably of between 200 and 500 nm.

Such a layer thickness is sufficient to ensure good adherence. In the event of microscopic fractures forming, these can be safely taken up by a base layer with such dimensions.

According to another embodiment of the invention, the base layer is designed as a pure titanium layer.

This ensures good adherence to a base material made of titanium or of a titanium alloy and good connection to the surface layer of anatase or rutile.

According to another embodiment of the invention, the surface layer of anatase has a layer thickness of between 10 and 1000 nm, preferably of between 100 and 250 nm.

Since the titanium dioxide ceramic layer of rutile or anatase is brittle per se, a thin surface layer of this kind greatly reduces the risk of cracks forming. The layer thickness is sufficient, however, to achieve the desired properties for improved osseointegration and to ensure sufficient abrasion resistance during screwing into a hole in the bone.

According to another embodiment of the invention, the surface layer of rutile has a layer thickness of between 10 and 1000 nm, preferably of between 100 and 250 nm.

Here too, a sufficiently thin layer counteracts the formation of cracks, while the layer is still sufficiently thick to ensure good stability.

According to a preferred development of the invention, the base layer and the cover layer are designed as sputtered layers.

With layers applied in this way, it is possible, on the one hand, to achieve particularly good adherence and purity. On the other hand, the anatase layer or the rutile layer can be applied with particularly high purity. Moreover, a nanocrystalline layer is formed, resulting in a high degree of biocompatibility.

As far as the method is concerned, the object of the invention is further achieved by a method for producing an enossal implant, comprising the following steps:
making available a base structure in the form of an enossal implant which has an anchoring area for anchoring in bone, a neck area, and an attachment area for receiving an element that is to be applied;
plasma pretreatment of the base structure at least in the anchoring area, and
sputtering of a surface layer of anatase onto the intermediate layer, at least in the anchoring area.

With a production method of this kind, a nanocrystalline anatase layer is obtained on the surface of the anchoring area. This layer has a biocompatible nanostructured surface with a nanoroughness and a nanoporosity, permitting particularly good osseointegration. Such an anatase layer also has a germicidal action, which is of advantage for the implantation.

According to another embodiment of the invention, an intermediate layer of titanium is sputtered on prior to the sputtering on of the surface layer of anatase.

This ensures a reliable adherence of the surface layer. It also avoids problems that can be caused by stress cracks. Finally, an intermediate layer of pure titanium is important for the formation of the sputtered-on anatase layer in its advantageous surface morphology.

All in all, the layers thus applied in the sputtering process result in the surface layer being of a layer quality that is advantageous for implantation, with nanostructuring and a nanoporosity, which improves osseointegration.

In another embodiment of the invention, the step of plasma pretreatment includes plasma surface cleaning and plasma polishing.

This ensures particularly good adherence of the sputtered-on intermediate layer of titanium and of the anatase layer applied to the latter.

In an additional development of the invention, the method comprises the additional steps of:
plasma pretreatment of the base structure in the neck area;
sputtering of an intermediate layer of titanium onto the neck area; and
sputtering of a surface layer of rutile onto the intermediate layer, at least in the neck area.

This application of a layer of rutile onto the neck area means that, at the site where the implant passes through the oral mucosa, there is a smooth titanium dioxide layer of rutile, which allows the oral mucosa to accumulate tightly on the implant neck and avoids penetration of bacteria from the oral cavity to the jaw bone. The risk of inflammation around the implant (periimplantitis, mucositis) can thus be reduced. The smooth rutile surface aids the cleaning of the tooth implant and protects the implant from corrosion.

According to another embodiment of the invention, the method comprises the additional steps of:
plasma pretreatment of the base structure in the attachment area;
sputtering of an intermediate layer of titanium onto the attachment area, and
sputtering of a surface layer of rutile onto the intermediate layer in the attachment area.

In this way, the entire area lying within the oral cavity during the post-implantation healing phase can be provided with a smooth, biocompatible layer. Complications are thus avoided during the healing phase.

According to a further embodiment of the invention, the layers of titanium and titanium dioxide are applied by a pulsed reactive magnetron sputtering process (reactive pulse magnetron sputtering PMS), as is known in principle from DE-A-10 2004 024 351 and also from O. Zywitzki et al., “Structure and Properties of Crystalline Titanium Oxide Layers Deposited by Reactive Pulse Magnetron Sputtering” in Surface and Coatings Technology, 180-181 (2004) 538-543.

It is evident from this that the use of such a method leads to particularly advantageous properties of the anatase surface layer, which can be photocatalytically activated upon activation with UV radiation.

According to another embodiment of the invention, a base structure is used that is made of titanium or a titanium alloy, of plastic or of a ceramic, in particular of a zirconium oxide material or an aluminum oxide material.

Especially good adherence between the surface layer or intermediate layer and the base structure is achieved in particular when the base structure is composed of titanium or of a titanium alloy. In this case, the application of the intermediate layer of titanium may also be omitted, if appropriate, since its function can be taken over by the titanium base material.

In addition, the method according to the invention can also be carried out using other implant materials as base structure. For example, the surface of a ceramic implant, which is composed of a zirconium oxide material or an aluminum oxide material, i.e. of a material that tends naturally to be bioinert, can be prepared for good osseointegration by the method according to the invention.

It will be appreciated that the aforementioned features can be used not only in the respectively cited combination, but also in other combinations, without departing from the scope of the invention.

Further features and advantages of the invention will become clear from the following description of preferred illustrative embodiments and by reference to the drawing, in which:

FIG. 1 shows a view of an implant according to the invention;

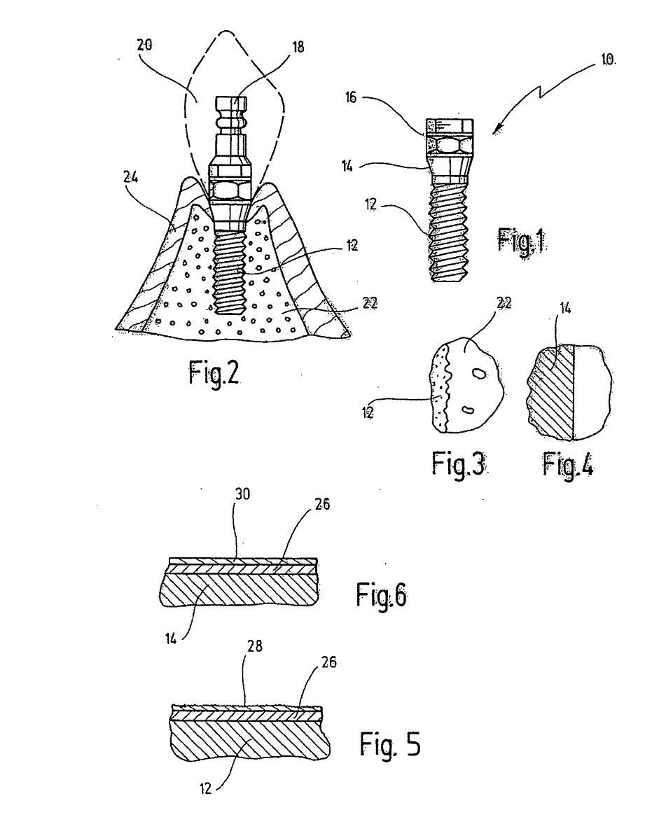

FIG. 2 shows a partially sectional view of an implant fitted into a hole drilled in a bone;

FIG. 3 shows a greatly enlarged detail of a boundary face between bone and anchoring area, with a schematically indicated nanoroughness;

FIG. 4 shows a greatly enlarged area of an implant surface in the neck area, with a smooth surface;

FIG. 5 shows an enlarged detail of the implant according to the invention, from which the layered construction in the anchoring area can be seen;

FIG. 6 shows an enlarged detail of the implant according to FIG. 1, from which the layered construction in the neck area can be seen, and

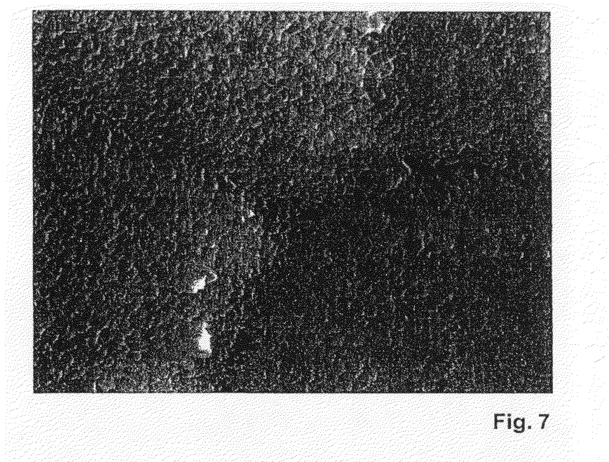

FIG. 7 shows a scanning electron microscope image of an implant surface with anatase coating.

In FIG. 1, an enossal implant according to the invention is designated overall by reference number 10. The implant 10 has an anchoring area 12, which is intended for anchoring in the jaw bone and which is provided with a thread. The anchoring area 12 is adjoined by a neck area 14, which is followed by an attachment area 16. The attachment area 16 is intended to receive an element that is to be applied, which element can be, for example, an abutment, a crown, a bridge or some other kind of tooth restoration. In the present case, the attachment area 16 is configured externally as a nut, in order to allow the implant 10 to be screwed into a jaw bone of a patient during the implantation.

The neck area 14 adjoining the anchoring area 12 widens in a cone shape in the direction toward the anchoring area 16 and has a smooth surface on which the oral mucosa 24 can bear tightly.

It will be appreciated that the implant 10 shown here is only given by way of an example and that the implant can be configured in any desired way.

In general, however, the anchoring area 12 to be anchored in the bone will be provided with a thread and, in this case, some kind of engagement piece for a screwing tool will be provided in the attachment area 16. However, it is also conceivable for an engagement piece for a screwing tool to be configured internally if, for example, an attachment part with an inner thread of a hollow cylinder is screwed onto the upper end of the implant 10. It is also conceivable that the anchoring area 16 is designed only as a continuation of the neck area 14 or forms the end of the neck area 14 directed away from the anchoring area 12.

FIG. 2 shows an implant 10 implanted in a jaw bone 22 of a patient. FIG. 2 indicates schematically how a superstructure 18 with a crown 20 can be applied on the anchoring area 16. This is generally done using dental cement.

The implant 10 according to the invention has a special surface coating, with a thin surface layer of anatase in the anchoring area 12 and a thin surface layer of rutile in the neck area 14. In addition, the anchoring area 16 can also be provided with a thin surface layer of rutile. On its surface, the anatase layer has a natural nanoroughness and nanoporosity, as is shown schematically and in a greatly enlarged form in FIG. 3. The surface roughness of the anatase layer thus permits a tight accumulation of bone tissue and promotes good osseointegration. As is shown schematically in the greatly enlarged view according to FIG. 4, the neck area 14, by contrast, is provided with a smooth surface layer of rutile. This guarantees a bioinert surface onto which the oral mucosa 24 can bear tightly such that a “seal” between oral cavity and jaw bone is obtained in the neck area 14. In this way, the passage of bacteria from the oral cavity into the jaw bone can be substantially avoided. The risk of inflammation around the implant (periimplantitis, mucositis) is minimized. By means of the smooth surface of the implant 10 in the neck area 14, it is easier to clean in the sensitive area between implant neck and oral mucosa 24, and it improves oral hygiene.

The layered construction preferably used in the anchoring area 12 is shown schematically and in an enlarged form in FIG. 5.

A thin intermediate layer 26 of pure titanium is sputtered onto the outer surface of the anchoring area 12, and a thin surface layer 28 of anatase is in turn sputtered onto the intermediate layer 26. The intermediate layer 26 of titanium serves as an adhesion promoter between the base material of the anchoring area 12 and the surface layer 28 of anatase. Since the surface layer 28 is ceramic, it is relatively brittle and may in some cases tend to form microscopic cracks. Any microscopic cracks appearing in the surface layer 28 extend at the very most as far as the intermediate layer 26 are and remedied in the latter.

The layered construction preferably used in the neck area 14 is shown in an enlarged form in FIG. 6.

A thin intermediate layer 26 of pure titanium is sputtered onto the outer surface of the neck area 14, and a thin surface layer 30 of rutile is in turn sputtered onto the intermediate layer 26. The intermediate layer 26 of titanium again serves as an adhesion promoter between the base material of the neck area 14 and the surface layer 30 of rutile.

Whereas the surface layer 28 composed of anatase according to FIG. 5 has a nanoroughness that promotes good osseointegration, the surface layer 30 of rutile in the neck area 14 is very smooth and allows the oral mucosa to accumulate tightly on the implant neck.

FIG. 7 shows a scanning electron microscope (SEM) image of a surface layer 26 composed of anatase. The nano-roughness and nanoporosity can be clearly seen. Both contribute to advantageous osseointegration.

According to the invention, the described surface coating is preferably applied by a pulsed reactive sputtering process onto the base structure from which the implant 10 is made. A sputtering process of this kind is known in principle from DE-A-10 2004 024 351 and also from O. Zywitzki et al., “Structure and Properties of Crystalline Titanium Oxide Layers Deposited by Reactive Pulse Magnetron Sputtering” in Surface and Coatings Technology, 180-181 (2004) 538-543.

Work is carried out here in a vacuum apparatus, as a result of which high-purity layers can be generated. The subsequent application of an anatase layer or of a rutile layer is carried out under the influence of oxygen, and a modification of the process parameters means that either an anatase layer or a rutile layer is deposited. By suitable setting of the process parameters, high-purity anatase or rutile layers can be deposited.

In the method according to the invention, plasma surface cleaning and plasma polishing of the base structure are carried out under vacuum in a first step.

A second step involves a sputtering of the connective layer of pure titanium.

An anatase layer or rutile layer is then deposited on the pure titanium layer by adjustment of specific process parameters and by delivery of oxygen during the sputtering. An anatase layer is preferably deposited in unipolar mode, whereas a rutile layer is preferably deposited in bipolar mode.

The layer thickness of the pure titanium layer is between 10 nm and 2000 nm, preferably between 200 and 500 nm.

The layer thickness of the surface layer of anatase or of rutile depends on the mechanical stress and is generally between 10 and 1000 nm, preferably between 100 and 250 nm. Since the properties of titanium dioxide are such that it tends to be brittle, the layer thickness is kept as small as possible and is preferably only about a half to a third of the layer thickness of the intermediate later of pure titanium.

The base material from which the base structure of the implant is made can be composed of a metal, of a ceramic or, if appropriate, of a plastic. The metal used is preferably titanium or a titanium alloy, whose biocompatibility and suitability for the production of enossal implants have been demonstrated in long-term studies.

If titanium or a titanium alloy is used as the base material, the sputtering-on of an intermediate layer of pure titanium may also be omitted, if appropriate. In this case, the previous plasma pretreatment of the base structure is sufficient, which plasma pretreatment preferably includes plasma surface cleaning and subsequent plasma polishing. The surface layer of anatase or rutile is sputtered on directly thereafter.

In this case, the base material itself takes on the described function of the intermediate layer.

If the material of the base structure is not composed of titanium or of a titanium alloy, the application of the intermediate layer of pure titanium is essential in order to produce good adherence to the base structure and to ensure the necessary elasticity in respect of the relatively brittle surface layer. The use of an intermediate layer of pure titanium is also essential for obtaining the advantageous properties of the anatase layer with nanoroughness and nanoporosity.

Alternative materials that may be considered for the base structure are in particular ceramic base materials, for example zirconium oxide materials or aluminum oxide materials. Zirconium oxide materials in particular, which have been recently developed, are distinguished by a particularly high degree of mechanical stability. The necessary osseointegration is ensured here by the surface layers according to the invention.

The surface layer of anatase produced by the pulsed reactive magnetron sputtering process can be made super-hydrophilic for a limited period of time directly prior to implantation, by photoactivation by means of UV light (for example “Blacklight Blue”) in the UVA range. In this way, directly prior to implantation, initial effects can be initiated at the interface between implant and bone tissue in order to obtain better and more rapid accumulation of bone tissue on the implant surface, such that particularly good osseointegration is achieved.

1. An enossal implant, with a base structure which is made of a base material and which has an anchoring area (12) for anchoring in bone, a neck area (14), and an attachment area (16) for receiving an element that is to be applied, wherein the surface of the anchoring area (12) has an intermediate layer (26) of titanium and has a surface layer (28) of titanium dioxide, which is composed mainly, preferably completely, of the anatase modification.

2. The implant as claimed in claim 1, wherein the neck area (14) has another surface than the anchoring area (12).

3. The implant as claimed in claim 2, wherein the neck area (14) is uncoated.

4. The implant as claimed in claim 2, wherein the neck area (14) has an intermediate layer (26) of titanium and a surface layer (30) of titanium dioxide in the rutile modification.

5. The implant as claimed in one of the preceding claims, wherein the attachment area (16) is uncoated.

6. The implant as claimed in one of claims 1 through 4, wherein the attachment area (16) has an intermediate layer (26) of titanium and a surface layer (30) of titanium dioxide in the rutile modification.

7. The implant as claimed in one of the preceding claims, wherein the base material is titanium or a titanium alloy.

8. The implant as claimed in one of claims 1 through 6, wherein the base material is composed of a plastic or a ceramic, in particular of a zirconium oxide material or an aluminum oxide material.

9. The implant as claimed in one of the preceding claims, wherein the surface layer (28) of anatase is designed as a photoactivatable layer.

10. The implant as claimed in one of the preceding claims, wherein the intermediate layer (26) has a layer thickness of between 10 nm and 2000 nm, preferably of between 100 and 1000 nm, particularly preferably of between 200 and 500 nm.

11. The implant as claimed in one of the preceding claims, wherein the intermediate layer (26) is designed as a pure titanium layer.

12. The implant as claimed in one of the preceding claims, wherein the surface layer (28) of anatase has a layer thickness of between 10 and 1000 nm, preferably of between 100 and 250 nm.

13. The implant as claimed in one of claims 4 through 12, wherein the surface layer (30) of rutile has a layer thickness of between 10 and 1000 nm, preferably of between 100 and 250 nm.

14. The implant as claimed in one of the preceding claims, wherein at least one layer, preferably both the intermediate layer (26) and also the cover layer (28, 30), is designed as a sputtered layer.

15. A method for producing an enossal implant, comprising the following steps:
making available a base structure in the form of an enossal implant (10) which has an anchoring area (12) for anchoring in bone (22), a neck area (14), and an attachment area (16) for receiving an element that is to be applied;
plasma pretreatment of the base structure at least in the anchoring area (12), and
sputtering of a surface layer (28) of titanium dioxide, which is composed mainly, preferably completely, of the anatase modification, onto at least the anchoring area (12).

16. The method as claimed in claim 15, wherein the step of plasma pretreatment includes plasma surface cleaning and plasma polishing.

17. The method as claimed in claim 15 or 16, comprising the additional steps of:
plasma pretreatment of the base structure in the neck area (14), and
sputtering of a surface layer (30) of titanium dioxide, which is composed mainly, preferably completely, of the rutile modification, onto at least the neck area (14).

18. The method as claimed in one of claims 15 through 17, comprising the additional steps of:
plasma pretreatment of the base structure in the attachment area (16), and
sputtering of a surface layer (30) of titanium dioxide, which is composed mainly, preferably completely, of the rutile modification, onto the attachment area (16).

19. The method as claimed in one of claims 15 through 18, wherein an intermediate layer (26) of pure titanium is sputtered on prior to the sputtering of the surface layer (28, 30) of titanium dioxide.

20. The method as claimed in one of claims 15 through 19, wherein the layers (26, 28, 30) are applied by a pulsed reactive magnetron sputtering process (reactive pulse magnetron sputtering PMS).

21. The method as claimed in one of claims 15 through 20, wherein a base structure is used that is made of titanium or a titanium alloy, of plastic or of a ceramic, in particular of a zirconium oxide material or an aluminum oxide material.
